(19) United States
(12) Patent Application Publication
(10) Pub. No.: US 2022/0345715 A1
(43) Pub. Date: Oct. 27, 2022

(54) AI PREDICTION FOR VIDEO COMPRESSION

(71) Applicant: ATEME, Velizy Villacoublay (FR)

(72) Inventors: Thomas Guionnet, Rennes (FR); Josselin Cozanet, Pleumeuleuc (FR)

(21) Appl. No.: 17/642,578

(22) PCT Filed: Sep. 9, 2020
(86) PCT No.: PCT/FR2020/051555

§ 371 Date: Mar. 11, 2022

(30) Foreign Application Priority Data
Sep. 11, 2019 (FR) 19 10014

(51) Int. Cl. H04N 19/137; H04N 19/105; H04N 19/52; H04N 19/176; G06N 3/08

(52) U.S. Cl. CPC H04N 19/137; H04N 19/105; H04N 19/52; H04N 19/176; G06N 3/08

(57) ABSTRACT

A method for encoding a first image within a first set of images, in which the first image is cut into blocks, each block being encoded according to one among a plurality of coding modes, is proposed, which comprises, for a current block of the first image, the determination, on the basis of at least one second image distinct from the first image and previously encoded according to an encoding sequence of the images of the first set of images, of a prediction of a feature of the current block in one or more third images from the first set of images distinct from the first image and not yet encoded according to the encoding sequence, and the use of the prediction to encode the current block while minimizing a flow-distortion criterion.

### CROSS-REFERENCE TO RELATED APPLICATIONS

This application is the U.S. national phase of the International Patent Application No. PCT/FR2020/051555 filed Sep. 9, 2020, which claims the benefit of French Patent Application No. 19 10014 filed Sep. 11, 2019, the entire content of which is incorporated herein by reference.

### FIELD

The present disclosure relates to a frame-encoding method and to a device for implementing this method. It is in particular applicable to coding frames of a video stream.

### BACKGROUND

Video data are generally subject to source coding aimed at compressing them in order to limit the resources required to transmit and/or store them. There are many coding standards, such as H.264/AVC (AVC standing for Advanced Video Coding), H.265/HEVC (HEVC standing for High Efficiency Video Coding) and MPEG-2 (developed by the Motion Picture Experts Group), that may be used to this end.

Consider a video stream comprising a set of frames. In conventional coding protocols, the frames of the video stream to be encoded are typically considered in an encoding sequence, and each is divided into sets of pixels that are also processed sequentially, for example starting at the top left and ending at the bottom right of each frame.

A frame of the stream is thus encoded by dividing a matrix of pixels corresponding to the frame into a plurality of sets, for example of blocks of set size (16×16, 32×32 or 64×64 pixels), and encoding these blocks of pixels in a given processing sequence. In certain standards, such as H.264/AVC, it is possible to break down blocks of 16×16 size (then called macro-blocks) into sub-blocks, for example of 8×8 or 4×4 size, in order to perform the encoding processing operations with a finer granularity.

Existing video-compression techniques may be divided into two main categories: on the one hand so-called “Intra” compression, in which the compression processing operations are carried out on the pixels of a single video frame or picture, and on the other hand so-called “Inter” compression, in which the compression processing operations are performed on a plurality of video frames or pictures. In the Intra mode, processing of a block (or set) of pixels typically comprises predicting the pixels of the block using (previously coded) causal pixels present in the frame in the process of being encoded (which is called the “current frame”), in which case “Intra prediction” is spoken of. In the Inter mode, processing of a block (or set) of pixels typically comprises predicting the pixels of the block using pixels of previously coded frames, in which case “Inter prediction” or “motion compensation” is spoken of.

These two types of coding are used in existing video codecs (MPEG2, H.264/AVC, HEVC) and are described, as regards the HEVC codec, in the article entitled “Overview of the High Efficiency Video Coding (HEVC) Standard”, by Gary J. Sullivan et al., IEEE Transactions on Circuits and Systems for Video Technology, vol. 22, no. 12, December 2012.

This exploitation of spatial and/or temporal redundancies makes it possible to avoid having to transmit or store the value of the pixels of each block (or set) of pixels, by representing at least some of the blocks by a pixel residual representing the difference (or the distance) between the prediction values of the pixels of the block and the actual values of the pixels of the predicted block. The pixel-residual information is present in the data generated by the encoder after transform (DCT for example) and quantization to decrease the entropy of the data generated by the encoder.

It is desirable to decrease as much as possible the additional information generated by the prediction of pixels and output from the encoder, in order to increase the efficiency of a coding/compression protocol at a given distortion level. Conversely, it is also possible to seek to decrease this additional information in order to increase the efficiency of a coding/compression protocol at a given encoder output bit rate.

A video encoder typically makes a choice of encoding mode corresponding to a selection of encoding parameters for a processed set of pixels. This decision may be made such as to optimize a distortion and bit-rate metric, the encoding parameters selected by the encoder being those that minimize a rate-distortion criterion. The choice of the encoding mode then has an impact on the performance of the encoder, both in terms of improvement in bit rate and in visual quality.

A video encoder may thus be designed so as to produce the highest possible quality while respecting a set of constraints corresponding to the use case in question. In the case of broadcast of television programs, the main constraints placed on video encoders are bit rate, processing time, latency (or delay), the characteristics of the video source, power consumption and cost. Processing time is critical for real-time broadcasting. Associated with the other constraints, it should be clear that, when designing a video encoder for real-time broadcasting, a compromise has to be made between quality and computational resources. Increasing the available computational resources makes it possible to improve quality. Similarly, bit rate places a limit on the quality that it is possible to achieve. Increasing bit rate thus makes it possible to improve quality.

Quality also depends on latency. Thus, in order to maximize encoding quality, certain video encoders implement a so-called “lookahead” technique whereby frames taking part in the encoding process are temporarily stored in a buffer memory before actually being encoded. This storage in memory of frames before processing by the video encoder makes it possible to implement frame analysis and processing tools from which the encoder may benefit, but introduces a latency into the encoding process, which latency is induced by the storage in memory.

In systems in which latency is permitted, coding efficiency may be maximized by storing frames in memory before processing by the encoder. Conversely, when latency is forbidden, coding efficiency is limited by the absence of storage. However, in the case of a live broadcast, it is desirable to have not only a low latency, but also a low bit rate and a high video quality.

There is thus a need for a frame-encoding method that addresses the drawbacks set out above.

### SUMMARY

This disclosure improves the situation.

According to a first aspect, a method is provided for encoding a first frame in a first set of frames, wherein the first frame is divided into blocks, each block being encoded in one among a plurality of coding modes, the method comprising, for a current block of the first frame: determining, on the basis of at least one second frame distinct from the first frame and encoded previously in an encoding sequence of the frames of the first set of frames, a prediction of a characteristic of the current block in one or more third frames of the first set of frames distinct from the first frame and still to be encoded in the encoding sequence; and using the prediction to encode the current block such as to minimize a rate-distortion criterion.

Advantageously, the provided method uses, to encode a current block of a current frame (in the process of being encoded), a prediction of a characteristic of the current block in one or more frames still to be encoded, this making it possible to avoid, completely or partially, the need to use the so-called lookahead technique whereby frames still to be encoded are buffered upstream of encoding, so as to carry out an analysis using these frames with a view to computing the characteristic. The latency generated by this lookahead may thus be decreased, or even completely eliminated.

In one or more embodiments, the prediction may be determined on the basis of at least one already-encoded frame in the set of frames. These embodiments advantageously make it possible to determine the prediction on the basis alone of already-encoded frames, and hence there is no need to store still-to-be-encoded frames in memory for the purposes of determining the prediction.

In one or more embodiments, the characteristic may comprise a cost of propagation of the current block to the one or more third frames of the first set of frames.

In one or more embodiments, the characteristic may comprise a measurement of presence of a transition in the current block.

In one or more embodiments, the characteristic may comprise a measurement of the variation, in the current block, in the amount of information over time.

In one or more embodiments, the prediction of the current block may further be determined on the basis of at least one fourth frame distinct from the first frame and still to be encoded in the encoding sequence. These embodiments advantageously make it possible to determine the prediction not only on the basis of already-encoded frames, but also on the basis of frames still to be encoded insofar as the latter are available for the determination of the prediction, i.e. when such frames are stored in memory. The determination of the prediction may thus be refined in cases where, because they are stored in memory, frames of the set of frames to be encoded that are still to be encoded are available.

In one or more embodiments, the prediction of the characteristic of the current block is determined using an artificial-intelligence algorithm such as, for example, a supervised learning algorithm.

In one or more embodiments, the provided method may then comprise a phase of training a neural network, this training phase being performed using a second set of frames, the training phase comprising, for a current block of a current frame of the second set of frames: determining, on the basis of at least one frame of the second set of frames, which at least one frame is distinct from the current frame and still to be encoded in an encoding sequence of the frames of the second set of frames, a reference prediction of the characteristic of the current block in a frame of the second set of frames, which frame is distinct from the current frame and still to be encoded in the encoding sequence of the second set of frames; and performing a phase of training the neural network on the basis of input data, and on the basis of the reference prediction of the current block, which prediction is comprised in reference data, to generate a prediction model for predicting the characteristic of the current block in the frames of the second set of frames still to be encoded in the encoding sequence.

In one or more embodiments, the plurality of coding modes may comprise at least one coding mode based on prediction by temporal correlation using a plurality of frames of a set of frames to be encoded. The method may then further comprise, for a current block of a current frame of the second set of frames: determining a motion-estimation vector of the current block, the motion-estimation vector pointing to a block correlated with the current block in a frame of the second set of frames that is distinct from the current frame and that has been previously encoded in the predefined encoding sequence of the frames of the second set of frames; and the neural network may furthermore be trained on the basis of the motion-estimation vector of the current block, which is comprised in the input data.

In one or more embodiments, the neural network may be trained on the basis of the current frame, which frame is comprised in the input data, and/or on the basis of a frame of the second set of frames that is distinct from the current frame and that has been encoded previously in the encoding sequence of the frames of the second set of frames, which frame is comprised in the input data.

In one or more embodiments, the neural network may be chosen to be a convolutional neural network.

In one or more embodiments, the prediction of the characteristic of the current block may be determined using the prediction model, on the basis of the first frame and on the basis of the at least one second frame, which frames are comprised in input data of the prediction model.

In one or more embodiments, the plurality of coding modes may comprise at least one coding mode based on prediction by temporal correlation using a plurality of frames of the first set of frames, the provided method then further comprising: determining a motion-estimation vector of the current block, the motion-estimation vector pointing to a block correlated with the current block in a frame of the first set of frames that is distinct from the first frame and that has been previously encoded in the predefined encoding sequence of the frames of the first set of frames; and the prediction of the current block may be determined using the prediction model, on the basis of the motion-estimation vector, which is comprised in the input data of the prediction model.

The provided method is particularly, though not exclusively, recommendable for encoding or compressing a frame of a sequence of frames according to a protocol such as H.261, MPEG-1 Part 2, H.262, MPEG-2 Part 2, H.264, AVC, MPEG-4 Part 2, H.265, HEVC or SHVC (Scalable HEVC). However, it is also recommendable for encoding frames, for example of a video sequence, according to any video encoding protocol operating on frames divided into blocks, in particular in which the blocks are encoded in a plurality of coding modes comprising at least one coding mode based on prediction by temporal or spatial correlation.

The provided method is particularly highly, although non-limitingly, recommendable for encoding or compressing a frame of a sequence of frames corresponding to one or more multimedia contents distributed live, using a technology for broadcasting multimedia content over the Internet, for example according to a protocol such as HTTP Live Streaming (HLS), HTTP being the acronym of HyperText Transfer Protocol, Microsoft Smooth Streaming (MSS), HTTP Dynamic Streaming (HDS), MPEG Dynamic Adaptive Streaming over HTTP (MPEG-DASH), or HTTP Adaptive Streaming (HAS), or using a technology for broadcasting multimedia televisual contents over a television network, for example according to a standard of the Digital Video Broadcast (DVB), or of the Advanced Television Systems Committee (ATSC).

The provided method will possibly advantageously be implemented in any device configured to encode or compress a frame of a sequence of frames, in particular corresponding to one or more multimedia contents distributed live, for example according to a protocol such as MPEG-DASH, HLS, HDS, MSS, or HAS, such as, non-limitingly, any computer, server, piece of broadcast-network head-end equipment, piece of broadcast-network equipment, etc.

According to a second aspect, a frame-encoding device is provided, this frame-encoding device comprising an input interface configured to receive a first frame of a set of frames, and a frame-encoding unit, operatively coupled to the input interface, and configured to divide the first frame into blocks, and to encode each block in one among a plurality of coding modes according to the provided method.

According to another aspect, the following are provided: a computer program, which is loadable into a memory associated with a processor, and comprises segments of code for implementing the steps of the provided method on execution of said program by the processor, and a dataset representing, for example in compressed or encoded format, said computer program.

Another aspect relates to a non-volatile medium for storing a computer-executable program, comprising a dataset representing one or more programs, said one or more programs comprising instructions that, on execution of said one or more programs by a computer comprising a processing unit operationally coupled to memory means and to an input/output interface module, cause the computer to encode a first image divided into blocks according to the provided method.

### BRIEF DESCRIPTION OF THE DRAWINGS

Other particularities and advantages of the present disclosure will become apparent on reading the following description of non-limiting examples of embodiment, with reference to the appended drawings, in which:

FIG. 1 is a diagram illustrating one example of an encoder architecture, according to one or more embodiments.

FIG. 2 is a block diagram illustrating the lookahead technique.

FIG. 3 is a diagram illustrating one example of frame re-ordering in an encoding mode employing B-frames.

FIG. 4a illustrates one example of a configuration of a lookahead-unit buffer memory comprising 3 portions.

FIG. 4b illustrates one example of an encoder incorporating an MB-tree analysis module and using a lookahead unit the memory of which has a structure comprising three buffer memories.

FIG. 4c illustrates one example of a structure for storing frames of a source video sequence within a lookahead unit.

FIG. 5 is a diagram illustrating the provided method according to one or more embodiments.

FIG. 6a is a diagram illustrating a frame-encoding system configured to implement the provided method according to one or more embodiments.

FIG. 6b is a diagram illustrating a system configured to implement the provided method according to one or more embodiments.

FIG. 6c is a diagram illustrating a system configured to implement the provided method according to one or more other embodiments.

FIG. 6d is a diagram illustrating a system configured to implement the provided method according to one or more embodiments.

FIG. 6e is a diagram illustrating a system configured to implement the provided method according to one or more embodiments.

FIG. 7a is a diagram illustrating a system configured to implement a training phase according to one or more embodiments.

FIG. 7b is a diagram illustrating a system configured to implement the provided method according to one or more embodiments.

FIG. 8 is a diagram illustrating one example of an architecture of a device configured to implement the provided method according to one or more embodiments.

### DETAILED DESCRIPTION

In the following detailed description of embodiments of the disclosure, many specific details are presented to provide a more complete understanding. Nevertheless, those skilled in the art will understand that embodiments may be implemented without these specific details. In other cases, features that are well known have not been described in detail to avoid needlessly complicating the description.

The present description refers to functions, engines, units, modules, platforms, and illustrations of diagrams of the methods and devices according to one or more embodiments. Each of the described functions, engines, modules, platforms, units and diagrams may be implemented in the form of hardware, software (including in the form of firmware or middleware), microcode, or any combination thereof. In the case of implementation in software form, the functions, engines, units, modules and/or illustrations of diagrams may be implemented by computer-program instructions or software code, which may be stored or transmitted on a computer-readable medium, including a non-volatile medium, or a medium loaded into the memory of a generic or specific computer, or of any other programmable apparatus or device for processing data, to produce a machine such that the computer-program instructions or the software code executed on the computer or the programmable apparatus or device for processing data form means of implementing these functions.

Embodiments of a computer-readable medium include, non-exhaustively, computer storage media and communication media, including any medium that facilitates the transfer of a computer program from one location to another. By “computer storage medium/media” what is meant is any physical medium that may be accessed by a computer. Examples of computer storage media include, non-limitingly, flash-memory components or disks or any other flash-memory devices (e.g. USB keys, memory sticks), CD-ROMs or other optical data-storage devices, DVDs, magnetic-disk-based data-storage devices or other magnetic data-storage devices, memory components for storing data, RAMs, ROMs, EEPROMs, memory cards (smart cards), SSD memories (SSD standing for solid state drive), and any other form of medium that may be used to transport or store data or data structures that may be read by a computer processor.

Furthermore, various forms of computer-readable medium are able to transmit or transport instructions to a computer, such as a router, gateway, server, or any equipment for transmitting data, whether it be a question of wired transmission (via coaxial cable, optical fiber, telephone wires, DSL cable, or Ethernet cable), of wireless transmission (via infrared, radio, cell, microwaves), or of transmission using virtualized transmitting equipment (virtual router, virtual gateway, virtual tunnel end point, virtual firewall). The instructions may, depending on the embodiment, comprise code in any computer programming language or of any computer program element, such as, non-limitingly, assembly languages, C, C++, Visual Basic, HyperText Markup Language (HTML), Extensible Markup Language (XML), HyperText Transfer Protocol (HTTP), Hypertext Preprocessor (PHP), SQL, MySQL, Java, JavaScript, JavaScript Object Notation (JSON), Python, and bash scripting.

In addition, the terms “in particular”, “especially”, “for example”, “example” and “typically” are used in the present description to designate examples or illustrations of non-limiting embodiments, which do not necessarily correspond to embodiments that are preferred or advantageous with respect to other possible aspects or embodiments.

By “server” or “platform” what is meant in the present description is any point of service (whether virtualized or not) or device hosting data-processing operations, one or more databases, and/or data-communication functions. For example, non-limitingly, the term “server” or the term “platform” may refer to a physical processor that is operationally coupled with associated communication, database and data-storage functions, or refer to a network, group, set or complex of processors and associated data-storage and networking equipment, and to an operating system and one or more database systems and software applications that support the services and functions provided by the server. A computing device may be configured to send and receive signals, via one or more wireless and/or wired transmission networks, or may be configured to process and/or store data or signals, and may therefore operate as a server. Thus, equipment configured to operate as a server may include, by way of non-limiting examples, dedicated rack-mounted servers, desktops, laptops, service gateways (sometimes referred to as “boxes” or “residential gateways”), multimedia decoders (sometimes called “set-top boxes”) and integrated equipment combining various functionalities, such as two or more of the functionalities mentioned above. The servers may vary widely in their configuration or capabilities, but a server will generally include one or more central processing units and a memory. A server may thus include one or more mass-memory devices, one or more power supplies, one or more wireless and/or wired network interfaces, one or more input/output interfaces, and one or more operating systems, such as Windows Server, Mac OS X, Unix, Linux, FreeBSD, or an equivalent.

By multimedia content, what is meant in the present description is any audio and/or video content, audiovisual content, music, sound, image, or interactive graphical interface, and any combination of these types of content.

The terms “network” and “communication network” such as used in the present description refer to one or more data links which may couple or connect equipment, possibly virtualized equipment, so as to allow the transport of electronic data between computer systems and/or modules and/or other electronic devices or equipment, such as between a server and a client device or other types of devices, including between wireless devices coupled or connected by a wireless network, for example. A network may also include a mass memory for storing data, such as an NAS (network attached storage), an SAN (storage area network), or any other form of medium readable by a computer or by a machine, for example. A network may comprise, in whole or in part, the Internet, one or more local area networks (LANs), one or more wide area networks (WANs), wired connections, wireless connections, cellular connections, or any combination of these various networks. Similarly, subnets may use various architectures or be compliant or compatible with various protocols, and interoperate with larger networks. Various types of equipment may be used to make various architectures or various protocols interoperable. For example, a router may be used to provide a communications link or a data link between two LANs that would otherwise be separate and independent.

The terms “operationally coupled”, “coupled”, “mounted” and “connected” and the various variations and forms thereof used in the present description refer to couplings, connections and mountings that may be direct or indirect, and that in particular comprise connections between electronic equipment, or between portions of such equipment, that allow operations and functions such as described in the present description. In addition, the terms “connected” and “coupled” are not limited to physical or mechanical connections or couplings. For example, an operational coupling may include one or more wired connections and/or one or more wireless connections between two or more pieces of equipment, allowing simplex and/or duplex communication links to be set up between the equipment or portions of the equipment. According to another example, a connection or an operational coupling may include a coupling via a wired and/or wireless link, to allow communication of data between a server of the proposed system and another piece of equipment of the system.

The terms “application” or “application program” (AP) and their variants (app, webapp, etc.) such as used in the present description correspond to any tool which functions and is operated by means of a computer, to provide or execute one or more functions or tasks for a user or another application program. In order to interact with an application program, and to control it, a user interface may be provided on the equipment on which the application program is implemented. For example, a graphical user interface (GUI) may be generated and displayed on a screen of the user device, or an audio user interface may be rendered to the user using a loudspeaker, headphones or an audio output.

The term “current” such as used in the present description in relation to a frame (“current frame”) or a frame segment, such as for example a block (“current block”) for a frame divided into blocks, refers to a frame or frame segment in the process of being processed, for example in the process of being encoded, analyzed, compressed, etc. In particular, the terms “current frame” refer to a frame in the process of being encoded among the frames of a set of frames, encoding of the current frame possibly comprising implementation of the provided method on the current frame, and the terms “current block” refer to a block in the process of being encoded in a current frame divided into blocks encoded in an encoding sequence of the blocks of the frame, encoding of the current block possibly comprising implementation of the provided method on the current block. In the present description, the current frame will possibly be associated with a time index, for example the index “t”, to distinguish it from already-encoded frames (which will possibly be associated with time indices less than t, such as “t−1”, “t−2”, . . . , “t−k” for a set of k frames), and still-to-be-encoded frames (which will possibly be associated with time indices greater than t, such as “t+1”, “t+2”, . . . , “t+n” for a set of n frames).

In the present description, with respect to delivery, the terms “in real time”, “in linear mode”, “in linear TV mode”, “in dynamic mode” and “live” or “in live mode” are used interchangeably to designate live or dynamic delivery of a multimedia content in a system for delivering contents to terminals, comprising in particular the delivery of the content as it is generated, as opposed to the delivery of a previously generated content, on request by a user (delivery on request or delivery in static mode), such as, for example, a content stored on a server, and made available to users via a video-on-demand (VOD) service.

In the present description, the terms “live content” refer to a content, for example a multimedia content, delivered, for example OTT, in dynamic mode (as opposed to in static mode). A live content will typically be generated by a television channel, or by any type of producer of televisual media, and will moreover be broadcast over a network for broadcasting multimedia content, in addition to being made available on content servers in an OTT delivery system.

In the present description, the terms “video input signal” or “input video stream” refer to a signal carrying data corresponding to a set of frames delivered as input to a device used for the implementation of the provided method. The set of frames may be designated by the terms “source video sequence”.

The provided method may be implemented by any type of encoder of a frame of a set of frames using a coding mode based on prediction by temporal and/or spatial correlation, such as for example a video codec in accordance with the standard(s) H.264/AVC, H.265/HEVC, and/or MPEG-2.

A video codec typically comprises a set of tools for video-sequence processing and representation. The specification of the video codec generally makes it possible to design a decoder to convert a bitstream compressed in accordance with the specification of the codec into so-called “reconstructed” video. The purpose of the video encoder is to convert a video called the “source” video into a bitstream in accordance with the specification of the codec. Depending on the implementation chosen for the encoder, a given source content may be represented in various ways by the same codec. Not all representations are equivalent. For example, for a given target bit rate, various representations will yield different qualities. Likewise, for a given target quality, various representations will yield different bit rates.

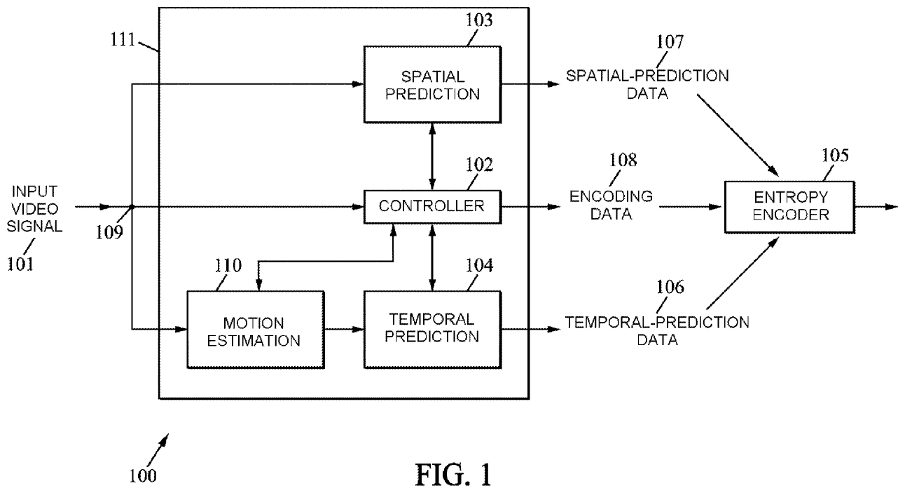

FIG. 1 illustrates one example of an encoder architecture, according to one or more embodiments.

With reference to FIG. 1, the encoder 100 receives at an input interface unit 109 as input an input video stream 101 comprising a plurality of frames to be processed to encode the stream. The encoder 100 comprises a controller 102, which is operatively coupled to the input interface unit 109, and which controls a motion-estimation unit 110 and a temporal-correlation-prediction unit 104 in order to make temporal-correlation predictions (such as, for example, Inter and Skip predictions, and so-called Merge and Affine predictions, depending on the video-encoding protocol used), and a spatial-correlation-prediction unit 103 for making spatial-correlation predictions (such as, for example, Intra predictions). The data received via the input interface unit 109 are input into the spatial-correlation-prediction unit 103, the motion-estimation unit 110, the temporal-correlation-prediction unit 104 and the controller 102. The controller 102, motion-estimation unit 110, temporal-correlation-prediction unit 104, and spatial-correlation-prediction unit 103 together form an encoding unit 111 that is operationally coupled to the input interface unit 109.

The spatial-correlation-prediction unit 103 generates spatial-correlation-prediction data 107 (for example Intra-prediction data) that are input into an entropy encoder 105. The motion-estimation unit 110 generates motion-estimation data that are delivered to the controller 102 and to the temporal-correlation-prediction unit 104 for the purposes of the Inter-mode prediction. The temporal-correlation-prediction unit 104 generates temporal-correlation-prediction data (for example Inter- or Skip-prediction data) that are input into the entropy encoder 105. For example, the data delivered to the decoder to obtain a prediction by temporal correlation may comprise a pixel residual and information regarding one or more motion vectors. This information regarding one or more motion vectors may comprise one or more indices identifying a predictor vector in a list of predictor vectors known to the decoder. The data delivered to the decoder to obtain a Skip prediction will typically not comprise pixel residuals, and will thus possibly comprise information identifying a predictor vector in a list of predictors known to the decoder. The list of predictor vectors used for Inter coding will not necessarily be identical to the list of predictor vectors used for Skip coding. The spatial-correlation-prediction data may comprise an Intra-coding mode. For a current block of a current frame, the entropy encoder 105 receives spatial-correlation-prediction data 107 or temporal-correlation-prediction data 106.

The controller 102 computes encoding data 108, which may comprise, in one or more embodiments, a pixel residual and data relating to the partition of the frame into elementary entities, after transform and quantification, which are also input into the entropy encoder 105. The data relating to the selected coding mode may be comprised in the temporal- or spatial-correlation-prediction data 106-107 for each encoded block.

The controller 102 is configured to control the spatial-correlation-prediction unit 103 and the temporal-correlation-prediction unit 104 in order to control the prediction data which are input into the entropy encoder 105 by the spatial-correlation-prediction unit 103 and the temporal-correlation-prediction unit 104, respectively. Depending on the encoding scheme implemented by the encoder 100, the controller 102 may further be configured to select, among various types of prediction mode (for example Intra mode, Inter mode or Skip mode depending on the coding modes implemented in the encoding unit 111), the prediction mode for which prediction data will be transmitted to the entropy encoder 105. Thus, the encoding scheme may comprise, for each processed frame set, a decision aimed at choosing the type of prediction for which data will be transmitted to the entropy encoder 105. This choice will typically be made by the controller 102, to decide which prediction mode (for example Inter, Intra or Skip prediction mode) to apply to the block in the process of being processed. This makes it possible to command spatial-correlation-prediction data 107 or indeed temporal-correlation-prediction data 106 to be sent to the entropy encoder 105, depending on the decision made by the controller 102.

The encoder 100 may be a computer, a computer network, an electronic component, or another apparatus comprising a processor operationally coupled to a memory, and, depending on the embodiment chosen, a data storage unit, and other associated hardware elements such as a network interface and a medium reader for reading a removable storage medium and writing to such a medium (not shown in the figure). The removable storage medium may be, for example, a compact disc (CD), a digital video/versatile disk (DVD), a flash disk, a USB stick, etc. Depending on the embodiment, the memory, the data storage unit or the removable storage medium contains instructions that, when they are executed by the controller 102, cause this controller 102 to perform or control the input interface unit 109, the spatial-correlation-prediction unit 103, the temporal-correlation-prediction unit 104, the motion-estimation unit 110 and/or the data-processing unit of the examples of implementation of the provided method that are described herein. The controller 102 may be a component that employs a processor or a computation unit to encode frames according to the provided method and to control the units 109, 110, 103, 104, 105 of the encoder 100.

Furthermore, the encoder 100 may be implemented in software form, as described above, in which case it will take the form of a program executable by a processor, or in hardware form, possibly in this case being an application-specific integrated circuit (ASIC) or a system on chip (SoC), or in the form of a combination of hardware and software elements, possibly in this case for example being a software program intended to be loaded into and executed by a field programmable gate array (FPGA). Systems on chip (SoCs) are embedded systems in which all the components of an electronic system are integrated into a single chip. Application-specific integrated circuits (ASICs) are specialized electronic circuits providing all the specific functionalities required by a given application. ASICs are usually configured during their manufacture and may only be simulated by the user. Field programmable gate arrays (FPGAs) are user-reconfigurable electronic circuits.

An encoder may also use hybrid architectures, such as, for example, architectures based on a CPU+FPGA, a graphics processing unit (GPU) or a multi-purpose processor array (MPPA).

The frame in the process of being processed is divided into blocks or coding units (CU), the shape and size of which are determined depending in particular on the size of the matrix of pixels representing the frame, and for example into square-shaped macroblocks of 16×16 pixels. A set of blocks is thus formed for which a processing sequence (also called the “processing path”) is defined. In the case of square-shaped blocks, it is for example possible to process the blocks of the current frame starting with the one located at the top left of the frame, followed by the one immediately to the right of the previous one, until the end of the first row of blocks is reached, before passing to the leftmost block of the row of blocks immediately below this first row, processing ending with the lowermost and rightmost block of the frame.

A “current block” (sometimes called the “original block”) is thus considered, i.e. a block in the process of being processed in the current frame. Processing of the current block may comprise partitioning the block into sub-blocks, in order to process the block with a finer spatial granularity than that obtained with the block. Processing of a block moreover comprises predicting the pixels of the block, based on the spatial correlation (same frame) or temporal correlation (previously coded frames) between the pixels. When a plurality of types of prediction—such as for example Intra prediction, Inter prediction, and/or Skip prediction—are implemented in the encoder, predicting the pixels of the block typically comprises selecting a type of prediction for the block and prediction information corresponding to the selected type, these together forming a set of encoding parameters.

Predicting the processed block of pixels makes it possible to compute a pixel residual, which corresponds to the discrepancy between the pixels of the current block and the pixels of the prediction block, and is transmitted in certain cases to the decoder after transform and quantization.

To encode a current block, a plurality of coding modes are thus possible and it is necessary to include, in the data generated by encoding, coding information 106-108 that indicate the coding mode chosen during encoding, in which mode the data were encoded. This coding information 106-108 may in particular comprise the coding mode (for example the particular type of predictive coding among Intra and Inter coding, or among Intra, Inter and Skip coding), the partition (in the case of one or more blocks partitioned into sub-blocks), motion information 106 in the case of predictive coding based on temporal correlation, and an Intra prediction mode 107 in the case of predictive coding based on spatial correlation. As indicated above, in “Inter” and “Skip” coding modes, the last two information items may also be predicted, for example based on the information of blocks neighboring the current block, in order to decrease their coding cost.

As indicated above, predictive coding based on spatial correlation includes a prediction, of the pixels of a block (or set) of pixels in the process of being processed, using the previously coded pixels of the current frame. There are various types of Intra predictive coding modes, such as the discrete-continuous (DC), vertical (V), horizontal (H) and vertical-left (VL) Intra prediction modes.

The H.264/AVC video coding standard provides 9 Intra prediction modes (comprising DC, H, V and VL prediction modes). The HEVC video coding standard for its part provides for a greater number of 35 intra prediction modes.

These video coding standards moreover make provision for particular cases with regard to performance of intra prediction. For example, the H.264/AVC standard permits blocks of 16×16 pixels to be divided into smaller blocks, the size of which may be as small as 4×4 pixels, in order to increase the granularity of the predictive-coding processing operations.

As indicated above, the information of the Intra prediction mode is predicted in order to decrease its coding cost. Specifically, the transmission, in the encoded stream, of an index identifying the Intra prediction mode has a cost that increases as the number of prediction modes usable increases. Even in the case of H.264/AVC coding, the transmission of an index between 1 and 9 identifying the Intra prediction mode used for each block among the 9 possible modes turns out to be expensive in terms of coding cost.

Thus, a most probable mode (MPM) is thus computed, which is used to code on a minimum of bits the most probable Intra prediction mode. The MPM is the result of the prediction of the Intra prediction mode used to encode the current block.

When the Intra mode is selected for encoding the current block, typically the pixel residual and the MPM will possibly be transmitted to the decoder.

Predictive coding in the mode referenced, in certain video coders, by the term “Inter” includes a prediction, of the pixels of a block (or set) of pixels in the process of being processed, using pixels that come from previously coded frames (which pixels therefore do not come from the current frame, in contrast to the Intra prediction mode).

The Inter prediction mode typically uses one or two sets of pixels located in one or two previously coded frames in order to predict the pixels of the current block. That said, it is possible to envision, for an Inter prediction mode, using more than two sets of pixels respectively located in previously coded frames that are distinct pairwise and the number of which is greater than two. This technique, which is called motion compensation, involves determining one or two vectors, called motion vectors, that respectively indicate the position of the set or sets of pixels to be used for the prediction in the previously coded frame or frames (which are sometimes called “reference frames”). With reference to FIG. 1, the vectors used for the Inter mode are to be chosen by the encoder 100 by means of the motion-estimation unit 110 and the temporal-correlation-prediction unit 104. The implementation of the motion estimation within the encoder 100 will therefore possibly make provision, depending on the case, to determine a single motion-estimation vector or indeed two motion-estimation vectors that point to potentially different frames.

The one or more motion-estimation vectors output from the motion-estimation unit 110 will be delivered to the temporal-correlation-prediction unit 104 with a view to generating prediction vectors, for example Inter prediction vectors. Specifically, each Inter prediction vector will possibly be generated from a corresponding motion-estimation vector.

The motion estimation may consist in exploiting the temporal correlation between pixels to study the movement of blocks between two frames. For a given block in the current frame (the “current block” or “original block”), the motion estimation makes it possible to select the most similar block (called the “reference block”) in a previously coded frame, called the “reference frame”, the motion of this block for example being represented with a two-dimensional vector (horizontal movement, vertical movement).

A video encoder may thus be designed to decide, for each elementary segment (for example for each block in the case of a division into blocks) of the frames of a video sequence to be encoded, the coding tools and the parameters to be applied. The better the decision, the better the encoding quality.

One deciding method consists in testing all the possibilities, for example all the various coding modes available to the encoder, in order to keep only the best combination. However, the number of combinations is in some cases so high that this method cannot be executed in a reasonable time.

The technique known as the lookahead technique, whereby frames of the source video are stored in memory before being processed by the encoder, thus providing, for encoding purposes, with respect to the frames currently being processed by the encoder, a set of future frames, which technique was described above, makes it possible to improve encoding quality by temporarily storing in memory frames of a video stream to be encoded before encoding them, so that when a frame is encoded the encoder has available to it at least one portion of the future of this frame in the video stream. Storage in memory thus makes it possible to implement frame analysis and processing tools from which the encoder may benefit, to encode frames of the video stream to be encoded.

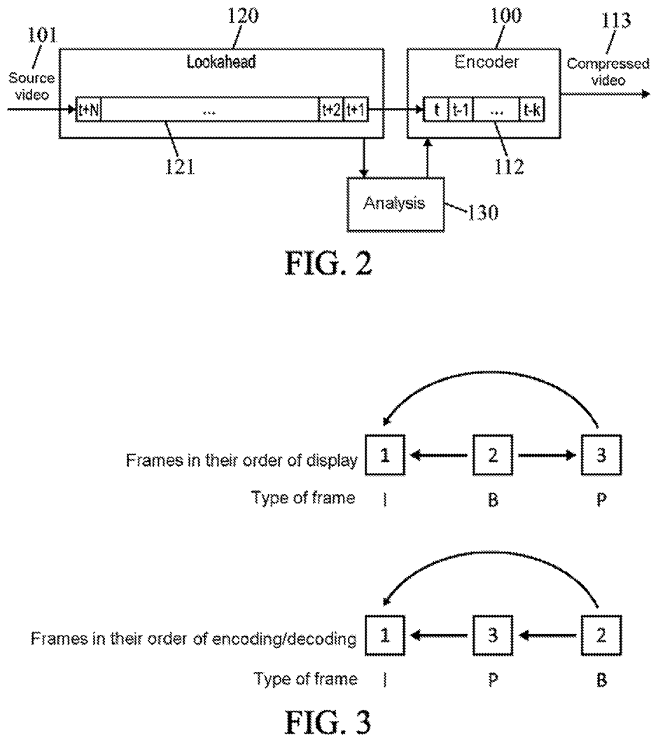

FIG. 2 is a block diagram illustrating the lookahead technique.

With reference to FIG. 2, a lookahead unit (120) comprising a memory is interposed between the encoder (100) and the input of the input video stream (101) (corresponding to a source video sequence comprising a set of frames) in order to store in the memory N frames (121) of the source video sequence (frames of time indices t+1, t+2, . . . , t+N) before encoding. The encoder encodes k frames (112) of the source video sequence (frames of time indices t, t−1, . . . , t−K) in the chosen encoding sequence, and produces as output a compressed video (113). A unit (130) for analyzing the frames of the source video sequence is able to process one or more frames (121) stored by the lookahead unit (120), so as to deliver, to the encoder (100), results of analysis of these frames (121).

However, in the case of a real-time encoding system, lookahead introduces a delay equal to the number of frames stored in memory. In practice, encoders typically implement memory storage delays of 0.5 to 5 seconds duration.

Two non-limiting examples of analysis of frames of the source video sequence that may use the lookahead technique are described below: transition detection, and the macroblock-tree algorithm.

### Example 1: Transition Detection

A video encoder encodes the frames making up the video sequence to be encoded in an encoding sequence defining an order of encoding of the frames of the video sequence. Depending on the prediction mode used to encode the frames, a plurality of types of frames may be defined, in order to distinguish between frames using encoding independent of the other frames (called “Intra” or I-frames), frames using encoding with unidirectional temporal prediction (called “predicted Inter” or P-frames) and frames using encoding with bidirectional temporal prediction (called “bi-predicted Inter” frames). Bi-predicted frames that may serve as reference for other frames are usually denoted Br-frames. In contrast, those which cannot be used as reference are denoted B-frames. The coding cost of bi-predicted inter frames is lower than the coding cost of predicted inter frames, which is itself lower than the coding cost of I-frames.

In the reference encoders of conventional standards the succession of the types of frames is set in advance. In contrast, certain advanced encoders dynamically adapt the types of frames to the content, and in particular to the presence of transitions between video scenes. In the case of a scene cut, it is desirable to encode the first frame of the new scene as an I-frame to avoid useless dependencies on the previous scene. Likewise, it is desirable to avoid I-frames at the end of a scene because it is an unnecessary waste of bits.

Thus, it may be useful, when encoding a frame, to know if there will be a transition in the near future, in order to choose the most suitable type of frame. The storage in memory (lookahead) makes it possible to execute methods for detecting transitions upstream of encoding, so as to deliver detected transitions to the encoder with a view to allowing, depending on the criterion used, the most suitable choice of coding mode to be made.

### Example 2: Macroblock Tree

Bit-rate control is an important element in the design of a video encoder, because the quality of the encoding is highly dependent thereon. Bit rate is allocated by adjusting quantization parameter (QP). In recent codecs, QP is configured in spatial subsets of pixels, i.e. in elementary segments of a frame. For example, in the HEVC codec, a plurality of types of nested partitions are defined: a partition into coding units (CU), a partition into prediction units (PU), and a partition in transform units. QP is set at the TU level. In AVC/H.264, QP is set in elementary frame segments called macroblocks. In the future VVC codec, QP is set in elementary frame segments called coding units (CUs). The mechanism used for bit-rate control must decide, for each frame, then for each block of the partitioned frame, which QP to use. Reference is then made to temporal and spatial allocation, respectively. As indicated above, the QP of a block may be allocated such as to minimize a rate-distortion criterion, preferably one taking into account a measurement of so-called perceptual distortion. It is also possible to take into account temporal-propagation effects. Specifically, at the frame level, the coding cost of a frame depends on the quality of its reference, i.e. of the frame used for the prediction of the frame in the process of being encoded. The better the reference, the better the prediction.

When encoding a frame, it may therefore be useful to ask whether this frame will serve as reference for other frames in the future. If this is the case, it will be preferable to allocate more bit rate to this frame than to the following ones. For example, an I-frame will generally be very important in the future. On the contrary, a B-frame is of no importance, since it will not ever serve as reference. The same reasoning applies at the block level (or, depending on the case, at the macroblock, TU or CU level). A block that serves as reference for many other blocks in the future is more important than a block that does not ever serve as reference. However, to know this information, it is necessary not only to look into the future, but also to take into account object motion. The so-called “macroblock tree” (MB-tree) algorithm is an example of implementation of this principle that substantially improves coding efficiency.

Specifically, the MB-tree algorithm makes it possible, on the basis of a frame divided into blocks, to adjust encoding parameters for each block based on a criterion that determines, for the block, whether it will serve as reference in the future, i.e. whether it will be used for the prediction of other blocks belonging to one or more frames that will be encoded subsequently.

### Example 3: Prediction of Complexity/Coding Cost

As explained in the previous example, bit-rate control is an important element in the design of a video encoder. In example 2, the MB-tree algorithm makes it possible to determine the relative importance of the blocks of a frame to future frames. This provides a criterion for allocation of spatial bit rate through per-block QP adjustment. Another criterion for bit-rate allocation is the variation as a function of time in block coding cost.

The intrinsic characteristics of a video vary over time. Thus, if a video is encoded at a set given QP, bit-rate variations are observed over time, because all the frames/blocks do not contain the same amount of information.

The principle of constant-bit-rate (CBR) control is to smooth variations in bit rate by modifying QP over time and by employing a buffer memory of set given size to smooth residual variations (Video Buffering Verifier or VBV). As QP varies over time, the quality of the rendered video varies accordingly. To ensure viewers perceive a consistent quality, the quality must vary as smoothly as possible while still meeting the set bit-rate and buffer-size (VBV) constraints. To achieve this goal, it is useful to anticipate variations in amount of information over time, this possibly being done using the lookahead principle described above, or using two-pass encoding. As noted above, the drawback of the lookahead principle is that it introduces latency. As for two-pass encoding, it does not work when broadcasting live.

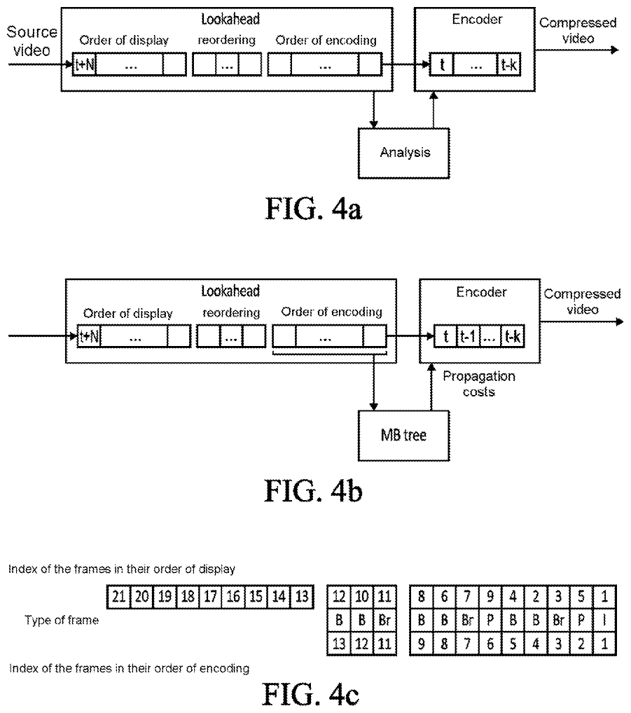

When the configuration of the analysis unit allows various analyzes to be carried out on the frames stored in memory in the lookahead unit, for example in parallel, various sequences of order of the frames in the memory of the lookahead unit may be considered. Specifically, the use of B-frames implies the frames must be reordered to be encoded and decoded, because if a B-frame refers to a past frame and to a future frame, the future frame must be encoded/decoded before the B-frame, as illustrated in FIG. 3.

FIG. 3, which illustrates an example of frames reordered for encoding with B-frames, shows three frames, one I-frame, one B-frame, and one P-frame, placed in order of display (I-frame of index 1, then B-frame of index 2, and lastly P-frame of index 3) and in order of encoding/decoding (I-frame of index 1, then P-frame of index 3, and lastly B-frame of index 2). In the figure, the arrows indicate the reference frames: the B-frame (index 2) uses the two frames of indices 1 and 3 as reference frames, while the frame of index 3 uses the frame of index 1 as reference frame.

Depending on the embodiment, some of the intended analyses of the frames of the input video sequence will be easier in the order of display, while others will be better suited to the order of encoding. Since these frames are stored in the lookahead unit, provision will possibly be made for the memory of the lookahead unit to be structured in a number of ways so as to allow the frames of the input video sequence that are stored therein to be reordered in one or more ways.

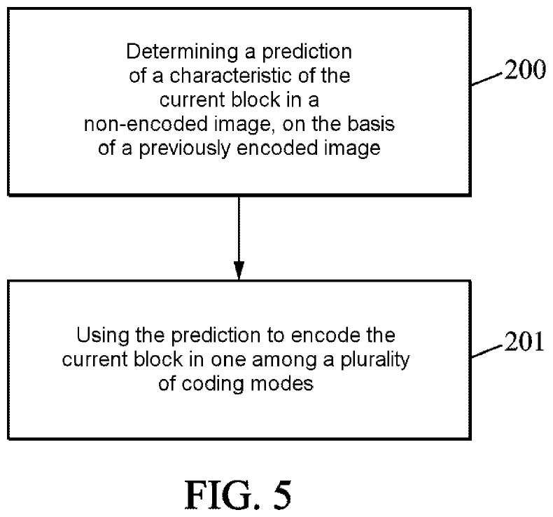

FIG. 4a illustrates one example of a configuration of a lookahead-unit buffer memory comprising 3 portions. As illustrated in the figure, the first portion will possibly for example store Na frames of the input video sequence in the order of display, the second portion will possibly store Nr frames in a temporary order of reordering, and the third portion will possibly store Ne frames in the order of encoding, the total number of stored frames being equal to N (N=Na+Nr+Ne). The use of a reordering buffer allows frames received in the order of display to be temporarily stored, in order to produce a sequence of frames in the order of encoding. For example, if at the input of the encoder frames are received in a certain order, for example frames of indices 1, 2, 3, but it is desired to encode frame 3 second, frame 2 may be temporarily stored in a reordering buffer, while waiting to receive frame 3.

FIG. 4b illustrates one example of an encoder incorporating an MB-tree analysis module and using a lookahead unit the memory of which has a structure comprising three buffer memories, as illustrated in FIG. 4a. The MB-tree algorithm uses the frames stored in the order of encoding to deliver as output to the encoder propagation costs in order to improve the efficiency of the encoding performed by the encoder to produce a compressed video. In this example, the lookahead portion and the encoding portion may employ any HEVC encoder, such as for example the ×265 HEVC encoder.

FIG. 4c illustrates a more detailed example of the structure for storing frames of a source video sequence within a lookahead unit. In this figure, each column corresponds to one frame stored in the lookahead unit. The first portion, on the left, contains Na frames in the order of display. The second portion, in the middle, contains Nr frames in the process of being reordered. The third portion, on the right, contains Ne frames in order of encoding. This corresponds exactly to the structure of FIG. 4a.

For each frame, the index of the frame in the order of display has been indicated, and, for each frame stored in the second and third portions, the type of frame and the index of the frame in the order of encoding have been indicated. Specifically, the type of frame may for example be generated by analyzing the frames in the order of display, and stored in memory, for example in the scheduling buffer.

Thus it may be seen that, in the left portion, the index is sorted in the order of display, whereas, in the right portion, the index is sorted in the order of encoding.

Each time a frame is encoded, the frames stored in memory are updated (one frame leaves to be encoded, another is stored in memory) while preserving their properties.

Thus, since transitions, and in particular gradual transitions, are detected more easily in the order of display, and, conversely, the MB tree is interested in the propagation of references in the order of encoding, FIG. 4a illustrates one example of a lookahead-unit storage configuration enabling these two algorithms to be executed by an analysis module, including in parallel.

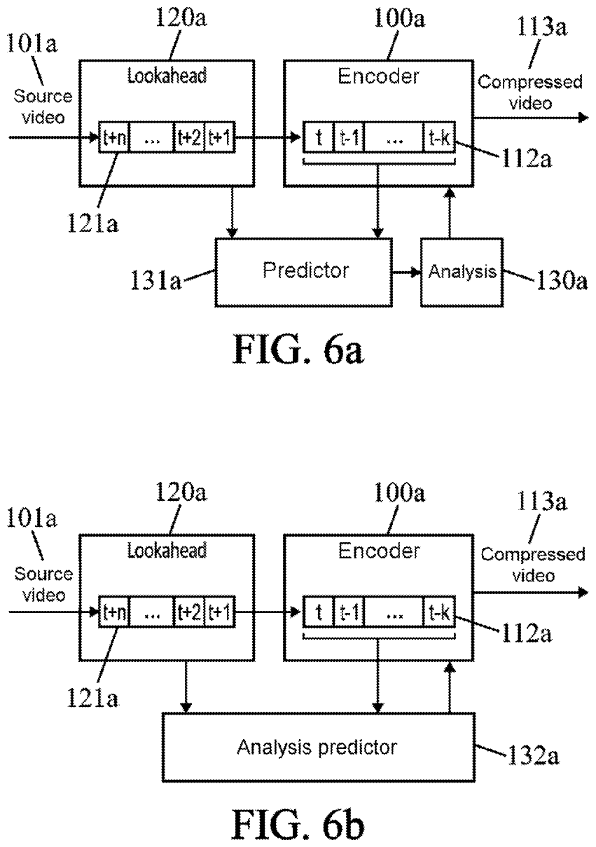

FIG. 5 is a diagram illustrating the provided method according to one or more embodiments.

Consider the case of a frame (called the “current frame”) drawn from a set of frames, for example a sequence of frames corresponding to a video sequence, and divided into blocks, and then encoded by encoding the blocks, each block being encoded in one among a plurality of coding modes.

A current block is thus considered to be coded in one coding mode among a plurality of coding modes, for example comprising one or more coding modes based on prediction by temporal correlation using a plurality of frames of the sequence of frames and/or one or more coding modes based on prediction by spatial correlation in the frame in the process of being encoded. The frames of the set of frames may be encoded with sequencing such as to define an encoding sequence of the frames of the set of frames.

With reference to FIG. 5, a prediction is determined (200) for at least one characteristic of the current block in one or more frames of the set of frames that are distinct from the current frame and still to be encoded in an encoding sequence, on the basis of at least one frame distinct from the current frame and encoded previously in the encoding sequence of the frames of the set of frames.

The determined prediction is then used (201) to encode the current block, for example such as to minimize a rate-distortion criterion, a coding mode that is considered to be optimal with regard to a decision criterion being selected, for the current block, from among a plurality of coding modes. An example of such a criterion, denoted [Math. 1] J, is of the form [Math. 21] J=D+λ·R, where [Math. 3] D is distortion, [Math. 4] λ is a Lagrange multiplier and [Math. 5] R is the bit rate associated with coding the estimated decision. Various types of criterion may be used, such as criteria using a so-called “objective” metric for computing distortion [Math. 6] D, such as the sum of absolute differences (SAD) or mean squared error (MSE), or criteria incorporating a measurement of visual distortion (also called “subjective distortion”). For example, the correlation between a block and its movement along a motion-estimation vector may be computed using the sum of absolute differences (SAD):

[Math. 7] SAD=ΣₓΣ_{y}|p_{xy}−p′_{xy}| (1)

where [Math. 8] p_{xy} is the pixel at position [Math. 9] (x, y) of the original block and [Math. 10] p′_{xy} the pixel at position [Math. 11] (x, y) of the reference block. A low SAD will be interpreted as an indication that the two blocks are very similar.

The provided method introduces the use of a prediction of what one or more characteristics of the current block (i.e. the block in the process of being encoded) will be like in the video in the future, i.e. in one or more frames of the set of frames (typically of the video sequence) that are still to be encoded in the encoding sequence. In one or more embodiments, this prediction is computed on the basis of past frames, i.e. on the basis of one or more frames that have been encoded previously in the encoding sequence.

Determining this prediction makes it possible to completely or partially avoid the use of the lookahead technique, i.e. the need to store in memory one or more frames providing knowledge as to what the video is like in the future, i.e. relative to the frame in the process of being encoded, and thus to decrease processing latency by decreasing the latency corresponding to the use of the lookahead technique. Specifically, it is possible to implement the provided method using, to determine the prediction, only frames that have already been encoded and that are therefore already available to the encoder, or using a lower number of stored frames still to be encoded. This makes it possible to obtain a video-encoding performance that might be good enough—in terms of latency, bit rate and video quality—to be compatible with live broadcasting.

In one or more embodiments, the prediction of the current block may further be determined on the basis of at least one frame still to be encoded in the encoding sequence. Thus, the determination of the prediction may in certain embodiments use at least one already-encoded frame of the set of frames (i.e. at least one past frame) and at least one still-to-be-encoded frame of the set of frames (i.e. at least one future frame). In one or more embodiments, a lookahead memory may be used to ensure future frames are available to determine the prediction, while limiting the number of frames in the set of frames that are stored in memory in order to decrease latency.

In one or more embodiments, the one or more predicted characteristics of the current block will possibly correspond to results of analyses to be performed upstream of encoding to improve its efficiency as described above. For example, in combination with an MB-tree analysis, the predicted characteristic will possibly correspond to a score that indicates, for the current block, its persistence as a reference for encoding future frames. This score will possibly, depending on the embodiment, comprise a propagation cost of the current block in future frames (i.e. frames still to be encoded) of the set of frames.

In combination with a transition-detection analysis, the predicted characteristic will possibly correspond, in one or more embodiments, to a score indicating whether a transition is present or not (for example a score indicating whether the frame belongs to the same scene as before, or does not belong to the same scene as before).

In combination with a rate-control analysis, the predicted characteristic will possibly correspond, in one or more embodiments, to a score that indicates, for the current block, the variation in amount of information over time, i.e. in blocks of future (still to be encoded) frames corresponding to the current block.

Below, frame-encoding systems will be considered that are configured to implement the provided method according to one or more embodiments comprising an encoder equipped with a buffer memory configured to store k frames, including a frame in the process of being encoded, and k —1 already-encoded frames. The already-encoded frames stored in the encoder may be considered to be past frames with respect to the frame in the process of being encoded, with respect to the encoding sequence of the frames used by the encoder. There is no particular penalty associated with keeping these frames in memory, except a little memory consumption. These past frames are therefore considered to be available no matter what the case.

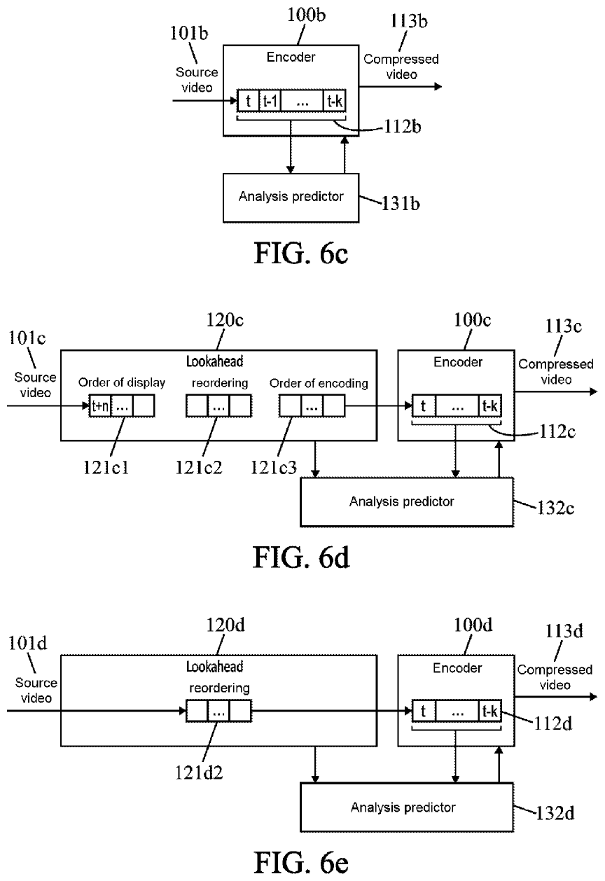

FIG. 6a illustrates a frame-encoding system configured to implement the provided method according to one or more embodiments.

With reference to FIG. 6a, a lookahead unit (120a) comprising a memory is interposed between the encoder (100a) and the input of the source video sequence (101a) in order to store in a memory n frames (121a) of the source video sequence (frames still to be encoded of time indices t+1, t+2, . . . , t+n) before encoding. The encoder encodes k frames (112a) of the source video sequence (frame in the process of being encoded of time index t, and frames already encoded of respective time indices t−1, . . . , t−k) in the chosen encoding sequence, and outputs a compressed video (113a). A prediction unit (131a) for making predictions as regards the frames of the source video sequence is configured to predict how the video will change in the future, on the basis of one or more past frames (frames (112a) already encoded or in the process of being encoded by the encoder) and optionally on the basis of one or more future frames (frames (121a) not yet being encoded, and stored in memory, for example in the lookahead unit (120a)). In one or more embodiments, the prediction unit (131a) for making predictions as regards the frames of the source video sequence is configured to deliver, to the analysis unit (130a), predictions of at least one characteristic of blocks of the frames to be encoded, on the basis of one or more frames among the past frames (112a) (frame in the process of being encoded of time index t, and frames already encoded of respective time indices t−1, . . . , t−k) stored in memory in the encoder (100a), as well as, in the embodiments illustrated in FIG. 6a, on the basis of one or more frames among the future frames (121a) (frames still to be encoded of time indices t+1, t+2, . . . , t+n) stored in memory in the lookahead unit (120a). The analysis unit (130a) may be configured to perform certain analysis processes on the frames to be encoded, such as, for example, as described above, transition detection and/or the implementation of an MB-tree algorithm, on the basis of the predictions delivered thereto by the prediction unit (131a). Preferably, the number (n) of frames stored in memory in the lookahead unit (120a), in embodiments using a lookahead unit, will be less than the number (N) of frames stored in memory in the lookahead unit when the proposed prediction module is not used (for example as illustrated in FIG. 2), so as to decrease the latency induced by this storage in memory even when frames of the source video sequence are stored in memory before encoding.

Thus, future frames may be analyzed without generating latency, or while generating a latency corresponding to the amount of memory storage used, and for example to the number of frames stored in memory in the lookahead unit used.

FIG. 6b is a diagram illustrating a system configured to implement the provided method according to one or more embodiments, corresponding to a variant, of the implementation illustrated in FIG. 6a, in which the analysis unit (130a) and the prediction unit (131a) are grouped together within an analysis prediction unit (132a) the functionalities of which correspond to the functionalities of the analysis unit (130a) and the functionalities of the prediction unit (131a) combined together. In one or more embodiments, the analysis prediction unit (132a) for analyzing and making predictions as regards the frames of the source video sequence is configured to deliver, to the encoder (100a), predictions of at least one characteristic of blocks of the frames to be encoded, on the basis of one or more frames among the past frames (112a) (frame in the process of being encoded of time index t, and frames already encoded of respective time indices t−1, . . . , t−k) stored in memory in the encoder (100a), as well as, in the embodiments illustrated in FIG. 6b, on the basis of one or more frames among the future frames (121a) (frames still to be encoded of time indices t+1, t+2, . . . , t+n) stored in memory in the lookahead unit (120a). The encoder (100a) may be configured to use certain processes to analyze the frames to be encoded, on the basis of the predictions and of the analysis results delivered thereto by the analysis prediction unit (132a).

FIG. 6c is a diagram illustrating a system configured to implement the provided method according to one or more other embodiments not using storage in memory before encoding of frames of the source video sequence.

With reference to FIG. 6c, and unlike the diagrams of FIGS. 6a and 6b, no lookahead unit is interposed between the encoder (100b) and the input of the source video sequence (101b) in order to store in memory frames of the source video sequence before encoding. The encoder encodes k frames (112b) of the source video sequence (frame in the process of being encoded of time index t, and frames already encoded of respective time indices t−1, . . . , t−k) in the chosen encoding sequence, and outputs a compressed video (113b). An analysis prediction unit (131b) for analyzing and making predictions as regards the frames of the source video sequence is configured to deliver, to the encoder (100b), predictions of characteristics of blocks of the frames to be encoded, solely on the basis of one or more frames among the past frames (112a) (frame in the process of being encoded of time index t, and frames already encoded of respective time indices t−1, . . . , t−k) stored in memory in the encoder (100b). The encoder (100b) may be configured to perform or use certain processes to analyze the frames to be encoded, on the basis of the predictions delivered thereto by the analysis prediction unit (131b). Thus, in this particular case, the analysis prediction unit (131b) relies solely on past frames to predict the desired analysis results. Latency (which would otherwise be induced by the storage in memory of frames of the source video before encoding) is thus advantageously minimized.

FIG. 6d is a diagram illustrating a system configured to implement the provided method according to one or more embodiments.

With reference to FIG. 6d, a lookahead unit (120c) comprising a memory is interposed between the encoder (100c) and the input of the source video sequence (101c) in order to store in a memory n frames (121c1; 121c2; 121c3) of the source video sequence before encoding. As illustrated in FIG. 4a, the storage in memory within the lookahead unit (120c) is structured with three memories: a first memory stores frames (121c1) of the source video sequence in the order of display of the frames, a second memory stores frames (121c2) of the source video sequence after reordering with respect to their order of display, and a third memory stores frames (121c3) of the source video sequence in the order of encoding of these frames. The encoder (100c) encodes k frames (112c) of the source video sequence (frame in the process of being encoded of time index t, and already encoded frames of respective time indices t−1, . . . , t−k) in the chosen encoding sequence, and produces as output a compressed video (113c). An analysis prediction unit (132c) for analyzing and making predictions as regards the frames of the source video sequence is configured to predict how the video will change in the future, on the basis of one or more past frames (frames (112c) already encoded or in the process of being encoded by the encoder) and optionally on the basis of one or more future frames (frames (121c1;121c2; 121c3) not yet being encoded, and stored in memory, for example in the lookahead unit (120c)). In one or more embodiments, the analysis prediction unit (132c) for analyzing and making predictions as regards the frames of the source video sequence is configured to deliver, to the encoder (100c), predictions of at least one characteristic of blocks of the frames to be encoded, on the basis of one or more frames among the past frames (112c) (frame in the process of being encoded of time index t, and frames already encoded of respective time indices t−1, . . . , t−k) stored in memory in the encoder (100c), as well as, in the embodiments illustrated in FIG. 6d, on the basis of one or more frames among the future frames (121c1; 121c2; 121c3) stored in memory in the lookahead unit (120c). The encoder (100c) may be configured to use certain processes to analyze the frames to be encoded, on the basis of the predictions and of the analysis results delivered thereto by the analysis prediction unit (132c). As indicated above, the number (n) of frames stored in memory in the lookahead unit (120c), in embodiments using a lookahead unit, will preferably be less than the number (N) of frames stored in memory in the lookahead unit when the proposed prediction module is not used (for example as illustrated in FIG. 2), so as to decrease latency.

FIG. 6e is a diagram illustrating a system configured to implement the provided method according to one or more embodiments, corresponding to a variant of the implementation illustrated by FIG. 6d, in which the lookahead unit (120d) comprises only one memory in which the frames (121d2) of the source video sequence (101d) are reordered. This limitation of the number of frames stored in memory in the lookahead unit, and therefore of the size of the memory of the lookahead unit, with respect to the embodiments illustrated in FIG. 6d, allows the latency induced by the use of the lookahead unit to be decreased, while retaining an analysis prediction unit (132d) configured to predict at least one characteristic for blocks of future frames, i.e. future frames in the encoding sequence of the frames (112d) in the process of being encoded within the encoder (100d), on the basis of the frames in the process of being encoded (112d) and of the frames (121d2) stored in memory in the lookahead unit (120d), with a view to producing the compressed video (113d).

In one or more embodiments, the prediction of a characteristic of the current block may be determined using an artificial-intelligence algorithm such as, for example, a supervised learning algorithm.

With reference to FIG. 4b, which illustrates a frame-encoding system using a lookahead unit in which frames of the source video sequence still to be encoded are reordered with a view to delivering them to an analysis unit implementing an MB-tree algorithm for determining the costs of propagation of a current block to the frames stored in memory in the lookahead unit, the analysis unit implementing the MB-tree algorithm, and the lookahead unit, may be replaced, in part or in whole, in one or more embodiments, by a prediction unit for predicting propagation cost that relies solely on past frames, i.e. on frames available to the encoder. In one or more embodiments, this prediction unit may be configured to implement an artificial-intelligence algorithm, and for example to use a neural network. For example, in one or more embodiments, the prediction unit may be configured to implement a supervised machine-learning algorithm.

The implementation of an artificial-intelligence algorithm may, in one or more embodiments, lead to a training phase being carried out, prior to the determination of the prediction of the characteristic of the current block in a so-called inference phase in which a prediction model will be used to determine the prediction, in order to determine parameters of the prediction model.

The training phase may be performed on a set of frames different from the set of frames comprising the frames to be encoded, in which case the algorithm used to determine the prediction will have been trained on data different from those used to make the prediction employed when encoding the frames of a set of frames.

In one or more embodiments, the training phase may comprise determining reference data comprising a reference prediction of the characteristic of a current block being used for training purposes, this current block belonging to a frame, of the set of frames being used for training purposes, called the current frame, in a frame of the set of frames that is distinct from the current frame and still to be encoded in the encoding sequence of the set of frames being used for training purposes, on the basis of another frame of the set of frames that is distinct from the current frame and still to be encoded in the encoding sequence. In one or more embodiments, the reference data may thus correspond to the characteristic that it is sought to predict using the artificial-intelligence algorithm.

These reference data (for example, in one or more embodiments, the reference prediction of the current block) and additionally input data may be used to train a neural network to generate a prediction model for predicting a characteristic of a current block in frames of the set of frames that are still to be encoded in an encoding sequence, for example to determine parameters of the model. The prediction model may then be used to determine a prediction of the characteristic in one or more still-to-be-encoded frames, on the basis of at least one already-encoded frame, such as proposed in one or more embodiments.

For example, in one or more embodiments, the reference data used in the training phase may comprise data generated by an analysis unit implementing an MB-tree algorithm, comprising for example propagation costs of blocks of one or more still-to-be-encoded frames that are stored in memory, for example in a lookahead unit as illustrated in FIG. 4b. The reference data may thus for example comprise the results of an MB-tree algorithm applied to the current frame of the training phase.

The prediction-model input data used to train this model may comprise, in one or more embodiments, data of the current frame of the training phase.

In one or more embodiments, the input data may comprise data from a frame preceding the current frame in an encoding sequence used in the training phase, i.e. from a frame already encoded, prior to the encoding currently being undergone by the current frame. For example, the input data may comprise data from the frame immediately preceding the current frame in the encoding sequence used in the training phase.

In one or more embodiments, the input data may comprise motion-estimation data regarding the motion of the current block between the current frame and a frame preceding the current frame in the encoding sequence used in the training phase. Depending on the embodiment, these estimation data may comprise a motion-estimation vector for the current block of the training phase, and optionally a value of an objective distortion metric, such as the sum of absolute differences (SAD) or the mean squared error (MSE), for the current block.

Thus, in one or more embodiments in which the plurality of coding modes comprises at least one coding mode based on prediction by temporal correlation using a plurality of frames of the set of frames that is used for training, for example an Inter coding mode, the provided method may comprise determining a motion-estimation vector expressing an estimation of the motion of the current block, the motion-estimation vector pointing to a block correlated with the current block in a frame of the set of frames that is distinct from the current frame and encoded previously in the encoding sequence of the frames of the set of frames that is used for training.

The prediction model, for example the neural network in the particular cases where the prediction model is implemented using a neural network, may, in one or more embodiments, be trained using the motion-estimation vector determined for the current block. Depending on the embodiment, the training of the prediction model, for example of the neural network, may further use a value of an objective distortion metric, such as the sum of absolute differences (SAD) or the mean squared error (MSE), for the current block.

As indicated above, in one or more embodiments, as a variant or in addition to using motion-estimation data, the neural network may be trained on the basis of the current frame of the training phase (the current frame then being comprised in the data input into the network for the purposes of training), and/or on the basis of a frame of the set of frames that is distinct from the current frame and encoded previously in the encoding sequence of the frames of the set of frames used for training (this frame then being comprised in the data input into the network for the purposes of training).

In one or more embodiments, the training phase therefore makes it possible to determine parameters of a prediction model, on the basis of model input data and reference data delivered to the model to train it. Depending on the embodiment, the input data may comprise data of the current frame comprising the current block being used for training purposes, data of a frame preceding the current frame in an encoding sequence of the frames of the set of frames being used for training purposes, and/or one or more motion vectors and a value of an objective metric, for example a value of an SAD metric, resulting from an estimation of the motion between these two frames. In embodiments in which the block characteristic to be predicted by the prediction model corresponds to a propagation cost representing a score of the persistence of the block in the frames still to be encoded of the set of frames to be encoded, the reference data may comprise propagation-cost data, which are for example obtained by applying an MB-tree algorithm to the current frame.

In one or more embodiments, the neural network used to determine a prediction of a characteristic of the current block may be a convolutional neural network. Such a network is typically configured to learn filtering operations, and hence the training of the parameters of the neural network comprises training filter parameters.

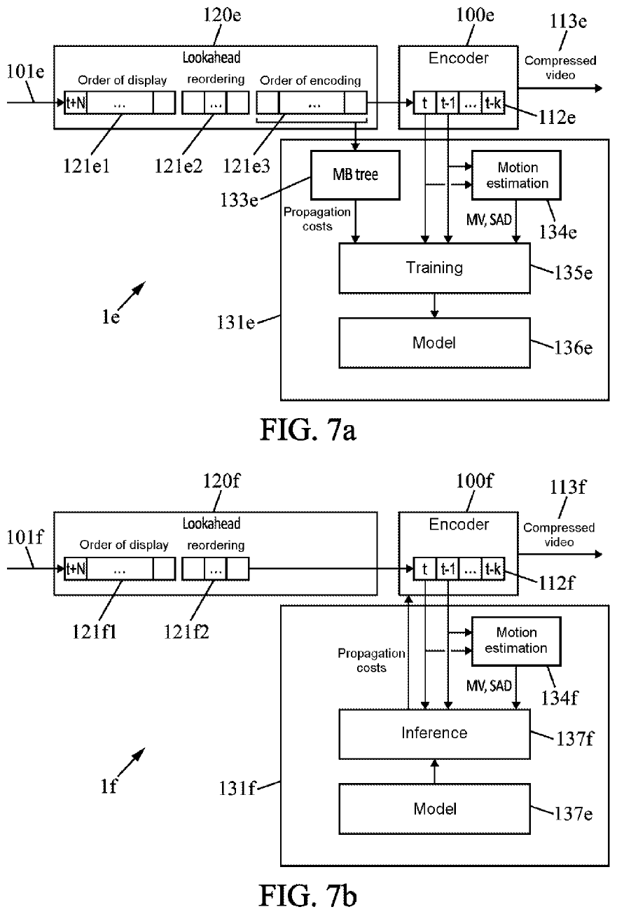

FIG. 7a illustrates a system configured to implement a training phase according to one or more embodiments.

With reference to FIG. 7a, the system (le) comprises a lookahead unit (120e) comprising a memory interposed between an encoder (100e) and the input of the source video sequence (101e) in order to store in a memory N frames (121e1; 121e2; 121e3) of the source video sequence (101e) before encoding. The encoder (100e) encodes k frames (112a) of the source video sequence (frame in the process of being encoded of time index t, and already-encoded frames of respective time indices t−1, . . . , t−k) in the chosen encoding sequence, and produces as output a compressed video (113e). For example, the lookahead unit (120e) and the encoder (100e) may employ an HEVC encoder, such as the ×265 HEVC encoder.

A prediction unit (131e) for making predictions as regards the frames of the source video sequence is configured to predict how the video will change in the future, on the basis of one or more past frames (frames (112e) already encoded or in the process of being encoded by the encoder) and optionally on the basis of one or more future frames (frames not yet being encoded, and stored in memory, for example in the lookahead unit (120e)). In one or more embodiments, the prediction unit (131e) for making predictions as regards the frames of the source video sequence is configured to implement a learning phase to generate an estimation model. In the example illustrated, the prediction unit (131e) comprises an analysis unit (133e) configured to execute an MB-tree algorithm on the basis of frame data (121e3) stored in memory in the lookahead unit (120e) and to generate propagation-cost data that are delivered, by way of reference data, to a learning unit (135e) of the prediction unit (131e). The learning unit (135e) is configured to receive these reference data, and input data comprising data of the current frame stored in the encoder (100e) (frame of time index “t”), data of a frame preceding the current frame in the encoding sequence (for example, as illustrated in the figure, the frame of time index “t—1”), as well as motion-estimation data (comprising for example motion vectors (MV) and values of an objective criterion (SAD)) regarding the motion between these two frames, which data are generated by a motion-estimation unit (134e) of the prediction unit (131e). The reference data may thus be generated, in one or more embodiments, by applying an MB-tree algorithm to future frames, i.e. future frames with respect to the frames in the process of being encoded. Depending on the embodiment, the input data may comprise data of the current frame and data of the frame preceding the current frame in the encoding sequence, but not comprise motion-estimation data regarding the motion between these two frames, or, conversely, comprise motion-estimation data regarding the motion between these two frames, but not comprise data of the current frame or data of the frame preceding the current frame in the encoding sequence. The learning unit (135e) may be configured to learn to estimate reference data on the basis of input data that are delivered thereto, to generate the parameters of an estimation model (136e).

In one or more embodiments, the system (1e) may use a neural network, to which, for training purposes, input data are delivered with a view to estimating reference data, such as described above. At the end of training, the parameters of the neural network are saved, the parameterized neural network providing the estimation model (136e).

FIG. 7b illustrates a system configured to implement the provided method according to one or more embodiments.

With reference to FIG. 7b, the system (10 comprises a lookahead unit (120f) comprising a memory interposed between an encoder (100f) and the input of the source video sequence (101f) in order to store in a memory a number of frames (121f1; 121f2) of the source video sequence (101f) before encoding. The encoder (100f) encodes k frames (112f) of the source video sequence (frame in the process of being encoded of time index t, and already-encoded frames of respective time indices t−1, . . . , t−k) in the chosen encoding sequence, and produces as output a compressed video (113f). For example, the lookahead unit (120f) and the encoder (100f) may employ the ×265 HEVC encoder.

A prediction unit (131f) for making predictions as regards the frames of the source video sequence is configured to predict how the video will change in the future, on the basis of one or more past frames (frames (112f) already encoded or in the process of being encoded by the encoder) and optionally on the basis of one or more future frames (frames not yet being encoded, and stored in memory, for example in the lookahead unit (120f)). In one or more embodiments, the prediction unit (131f) for making predictions as regards the frames of the source video sequence comprises an inference unit (137f) configured to determine a prediction of a characteristic of a current block of a current frame (frame in the process of being encoded of time index t), and to deliver, to the encoder (100f), the determined prediction. In the example illustrated in the figure, the predicted characteristic comprises a propagation cost of the current block, this corresponding to the learning phase illustrated by FIG. 7a, which uses reference data comprising propagation costs generated by applying an MB-tree algorithm. The system (10 therefore advantageously makes it possible to deliver propagation-cost data to an encoder, without having to employ an analysis unit configured to apply an MB-tree algorithm to data of future frames stored in memory in a lookahead unit.

In one or more embodiments, the types of input data employed in the learning phase may correspond to the types of input data employed in the inference phase (or prediction phase).

Depending on the embodiment, the data input into the inference unit (137f) may comprise data of the current frame stored in the encoder (100f) (frame of time index “t”), data of a frame preceding the current frame in the encoding sequence (for example, as illustrated in the figure, the frame of time index “t−1”), as well as motion-estimation data (comprising for example motion vectors (MV) and values of an objective criterion (SAD)) regarding the motion between these two frames, which data are generated by a motion-estimation unit (1340 of the prediction unit (131e), or indeed data of the current frame and data of the frame preceding the current frame in the encoding sequence but not motion-estimation data regarding the motion between these two frames, or, conversely, motion-estimation data regarding the motion between these two frames but not data of the current frame or data of the frame preceding the current frame in the encoding sequence.

In one or more embodiments, the system (10 may use a neural network, to which, after training, input data are delivered with a view to estimating a characteristic of a current block of a current frame in a set of frames to be encoded. The inference unit (1370 may be configured to apply the neural network with the parameters saved during training. The neural network may be configured to receive as input the same type of data as it was trained with, and to output estimated propagation costs, these replacing the propagation costs generated by an MB-tree algorithm. The portion of the lookahead unit (120f) which is no longer required is removed, this effectively decreasing encoding latency.

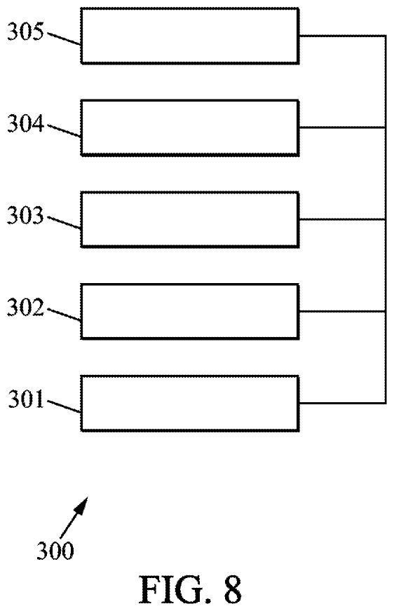

FIG. 8 illustrates an example of an architecture of a device for implementing the proposed method according to one or more embodiments.

With reference to FIG. 8, the device 300 comprises a controller 301, operationally coupled to an input interface unit 302, an output interface unit 303 and to a memory unit 304, which controls a prediction unit 305.

The input interface unit 302 is configured to receive, for example via a storage unit (for implementing a lookahead functionality) or a video-encoding unit (not shown in the figure), data corresponding to frames of a set of frames. The input interface unit 302 may further be configured to receive reference data and input data, to implement a training/learning phase and an inference phase, as described above, in embodiments in which the prediction unit 305 is configured to implement an artificial-intelligence algorithm such as, for example, a supervised machine-learning algorithm.

The output interface unit 303 is configured to deliver data generated by the prediction unit to a device configured to use these data, such as, for example, a video-encoding unit.

The controller 301 is configured to control the prediction unit 305 to implement one or more embodiments of the provided method.

The prediction unit 305 may be configured to determine a prediction of a characteristic of a current block, and to deliver this prediction via the output interface unit 303 to a video-encoding unit. In one or more embodiments, the prediction unit 305 may be configured to implement an artificial-intelligence algorithm, using a neural network, such as, for example, a supervised learning algorithm. In one or more embodiments, the prediction unit 305 may comprise an analysis unit configured to carry out an analysis of data of frames received via the input interface unit 302, such as, for example, an analysis using an MB-tree algorithm.

The device 300 may be a computer, a computer network, an electronic component, or another apparatus comprising a processor operationally coupled to a memory, and, depending on the embodiment chosen, a data storage unit, and other associated hardware elements such as a network interface and a medium reader for reading a removable storage medium and writing to such a medium (not shown in the figure). The removable storage medium may be, for example, a compact disc (CD), a digital video/versatile disk (DVD), a flash disk, a USB stick, etc. Depending on the embodiment, the memory, the data storage unit or the removable storage medium contains instructions that, when they are executed by the controller 301, cause this controller 301 to perform or control the input-interface unit 302, the output-interface unit 303, the memory unit 304, and the prediction unit 305 so as to implement the provided method. The controller 301 may be a component that employs one or more processors or a computation unit to encode frames according to the provided method and to control the units 302, 303, 304 and 305 of the device 300.

Furthermore, the device 300 may be implemented in software form, in hardware form, possibly in this case being an application-specific integrated circuit (ASIC), or in the form of a combination of hardware and software elements, possibly in this case for example being a software program intended to be loaded into and executed by an FPGA.

Depending on the chosen embodiment, certain acts, actions, events or functions of each of the methods described in the present document may be performed or occur in a different order to that in which they have been described, or may be added, merged or indeed not be performed or not occur, as the case may be. Furthermore, in certain embodiments, certain acts, actions or events are performed or occur concurrently and not successively.

Although described by way of a certain number of detailed examples of embodiment, the provided encoding method and the equipment for implementing the method comprise various variants, modifications and improvements that will appear obvious to anyone skilled in the art, and it will be understood that these various variants, modifications and improvements form part of the scope of the disclosure, such as defined by the following claims. In addition, various of the aspects and features described above may be implemented together, or separately, or indeed be substituted for each other, and all of the various combinations and sub-combinations of the aspects and features form part of the scope of disclosure. Furthermore, it is possible for certain of the systems and pieces of equipment described above to not incorporate all of the modules and functions described with respect to the preferred embodiments.

1. A method for encoding a first frame in a first set of frames, wherein the first frame is divided into blocks, each block being encoded in one among a plurality of coding modes, the method comprising, for a current block of the first frame:
determining, on the basis of at least one second frame distinct from the first frame and encoded previously in an encoding sequence of the frames of the first set of frames, a prediction of a characteristic of the current block in one or more third frames of the first set of frames distinct from the first frame and still to be encoded in the encoding sequence; and
using the prediction to encode the current block such as to minimize a rate-distortion criterion.

2. The method as claimed in claim 1, wherein the characteristic comprises a cost of propagation of the current block to the one or more third frames of the first set of frames.

3. The method as claimed in claim 1, wherein the characteristic comprises a measurement of presence of a transition in the current block.

4. The method as claimed in claim 1, wherein the characteristic comprises a measurement of the variation, in the current block, in the amount of information over time.

5. The method as claimed in claim 1, wherein the prediction of the current block is further determined on the basis of at least one fourth frame distinct from the first frame and still to be encoded in the encoding sequence.

6. The method as claimed in claim 1, wherein the prediction of the characteristic of the current block is determined using a supervised learning algorithm.

7. The method as claimed in claim 1, comprising a phase of training a neural network, this training phase being performed using a second set of frames and comprising, for a current block of a current frame of the second set of frames:
determining, on the basis of at least one frame of the second set of frames, which at least one frame is distinct from the current frame and still to be encoded in an encoding sequence of the frames of the second set of frames, a reference prediction of the characteristic of the current block in a frame of the second set of frames, which frame is distinct from the current frame and still to be encoded in the encoding sequence of the second set of frames; and
performing a phase of training the neural network on the basis of input data, and on the basis of the reference prediction of the current block, which prediction is comprised in reference data, to generate a prediction model for predicting the characteristic of the current block in the frames of the second set of frames still to be encoded in the encoding sequence.

8. The method as claimed in claim 7, wherein the plurality of coding modes comprises at least one coding mode based on prediction by temporal correlation using a plurality of frames of a set of frames to be encoded, the method further comprising, for a current block of a current frame of the second set of frames:
determining a motion-estimation vector of the current block, the motion-estimation vector pointing to a block correlated with the current block in a frame of the second set of frames that is distinct from the current frame and that has been previously encoded in the encoding sequence of the frames of the second set of frames; and
wherein the neural network is furthermore trained on the basis of the motion-estimation vector of the current block, which is comprised in the input data.

9. The method as claimed in claim 7, wherein the neural network is trained on the basis of the current frame, which frame is comprised in the input data, and/or on the basis of a frame of the second set of frames that is distinct from the current frame and that has been encoded previously in the encoding sequence of the frames of the second set of frames, which frame is comprised in the input data.

10. The method as claimed in claim 7, wherein the neural network is a convolutional neural network.

11. The method as claimed in claim 7, wherein the prediction of the characteristic of the current block is determined using the prediction model, on the basis of the first frame and on the basis of the at least one second frame, which frames are comprised in input data of the prediction model.

12. The method as claimed in claim 7, wherein the plurality of coding modes comprises at least one coding mode based on prediction by temporal correlation using a plurality of frames of the first set of frames, the method further comprising:
determining a motion-estimation vector of the current block, the motion-estimation vector pointing to a block correlated with the current block in a frame of the first set of frames that is distinct from the first frame and that has been previously encoded in the encoding sequence of the frames of the first set of frames;
and wherein the prediction of the current block is determined using the prediction model, on the basis of the motion-estimation vector, which is comprised in the input data of the prediction model.

13. A frame-encoding device comprising:
an input interface configured to receive a first frame of a first set of frames;
a frame-encoding unit, operatively coupled to the input interface, and configured to:
divide the first frame into blocks; and
encode each block in one among a plurality of coding modes;
wherein the frame-encoding unit is configured to, for a current block of the first frame:
determine, on the basis of at least one second frame distinct from the first frame and encoded previously in an encoding sequence of the frames of the first set of frames, a prediction of a characteristic of the current block in one or more third frames of the first set of frames distinct from the first frame and still to be encoded in the encoding sequence; and
use the prediction to encode the current block such as to minimize a rate-distortion criterion.

14-15. (canceled)

16. The device as claimed in claim 13, wherein the characteristic comprises a cost of propagation of the current block to the one or more third frames of the first set of frames.

17. The device as claimed in claim 13, wherein the characteristic comprises a measurement of presence of a transition in the current block.

18. The device as claimed in claim 13, wherein the characteristic comprises a measurement of the variation, in the current block, in the amount of information over time.

19. A non-volatile non-transitory medium for storing a computer-executable program, comprising a data set representing one or more programs, said one or more programs comprising instructions that, on execution of said one or more programs by a computer comprising a processing unit operationally coupled to memory means and to an input/output interface module, cause the computer to manage multimedia contents according to a method for encoding a first frame in a first set of frames, wherein the first frame is divided into blocks, each block being encoded in one among a plurality of coding modes, the method comprising, for a current block of the first frame:
determining, on the basis of at least one second frame distinct from the first frame and encoded previously in an encoding sequence of the frames of the first set of frames, a prediction of a characteristic of the current block in one or more third frames of the first set of frames distinct from the first frame and still to be encoded in the encoding sequence; and
using the prediction to encode the current block such as to minimize a rate-distortion criterion.

20. The non-volatile non-transitory medium as claimed in claim 19, wherein the characteristic comprises a cost of propagation of the current block to the one or more third frames of the first set of frames.

21. The non-volatile non-transitory medium as claimed in claim 19, wherein the characteristic comprises a measurement of presence of a transition in the current block.

22. The non-volatile non-transitory medium as claimed in claim 19, wherein the characteristic comprises a measurement of the variation, in the current block, in the amount of information over time.
